(19) United States
(12) Patent Application Publication
(10) Pub. No.: US 2018/0320839 A1
(43) Pub. Date: Nov. 8, 2018

(54) FLEXIBLE LED LIGHTING STRIP

(71) Applicant: Brenda Ann Briscoe, Waldorf, MD (US)

(72) Inventor: Brenda Ann Briscoe, Waldorf, MD (US)

(21) Appl. No.: 15/584,618

(22) Filed: May 2, 2017

(51) Int. Cl. F21S 4/26; F21V 19/00; F21S 4/22; F21L 4/02

(52) U.S. Cl. CPC F21S 4/26; F21V 19/001; F21Y 2103/10; F21L 4/027; F21S 4/22

(57) ABSTRACT

A flexible LED light strip is configured to be readily installed, removed, or relocated to any area requiring illumination. A plurality of interconnected LED lamps are carried on an elongate flexible material having a light reflective front surface and a light blocking back surface. A clear second film layer is joined to the first film layer to encapsulate the LED lamps. An electrical connector is provided at an end of the LED light strip for connection to a power supply. A back surface may have one or more fasteners for readily removing the LED light strip from one location to another.

### BACKGROUND OF THE INVENTION

The present invention relates to light emitting diode (LED) lighting and illumination strips and, more particularly, to flexible LED lighting strips.

LED lights are commonly used to illuminate an area and are typically hard wired for integration with the electrical distribution system providing electrical power to the area. Once installed, the LED lights will typically remain fixed in that location for their service life. The problem with existing products is that many individuals do not have the skills to hard wire the light, or that the electrical distribution system doesn't service the intended area. Similarly, if the individual needs light for more than one area, they must buy additional lighting.

As can be seen, there is a need for an improved consumers to utilize the same flexible LED lighting strip for a variety of lighting areas, and for numerous applications. The same strip can be used over and over again from one location to the next.

### SUMMARY OF THE INVENTION

In one aspect of the present invention, a flexible light emitting diode (LED) lighting strip, includes an elongate first film layer having a light reflective front surface and a light blocking back surface. A plurality of electrically interconnected LED lamps are attached in a spaced apart relation along a longitudinal length of the front surface of first film layer. A second film layer covers the LED lamps and is joined to the first film layer. One or more fasteners are attached to the back surface. A connector is provided in electrical communication with the LED lamps and is configured to connect with a power source.

The LED lighting strip may also include a battery pack, which may contain a rechargeable battery. The battery pack may be configured with a recharging circuit. The power source may be an AC to DC converter.

The flexible LED lighting strip may be formed by a fold defined along a side edge of the first film layer to form a pocket. A lateral edge of the second film layer may be received within the pocket and joined with the first film layer. The second film layer may be joined with the first film layer via a plurality of stitches extending through the fold. In some instances, the second film layer is joined with the first film layer via a weld along the fold. In others, the second film layer and the first film layer are joined in a watertight seal to encapsulate the plurality of LED lamps.

The one or more fasteners may be a length of pile material attached to the back surface. The one or more fasteners may include a magnet attached to the back surface. The magnet may be attached in a spaced apart relation along the longitudinal length of the LED lighting strip.

These and other features, aspects and advantages of the present invention will become better understood with reference to the following drawings, description and claims.

### BRIEF DESCRIPTION OF THE DRAWINGS

FIG. 1 is a perspective detail view of the invention shown in indeterminate length;

FIG. 2 is a perspective detail view of the invention shown in indeterminate length and demonstrating flexibility.

FIG. 3 is a bottom perspective view of the invention shown in indeterminate length.

FIG. 4 is a section view of the invention taken along line 3-3 in FIG. 3.

FIG. 5 is a perspective view of an invention component.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an improved LED lighting strip that may be readily installed and relocated from one area to another. The lighting strip is also flexible along its longitudinal length to facilitate mounting in a wide variety of locations.

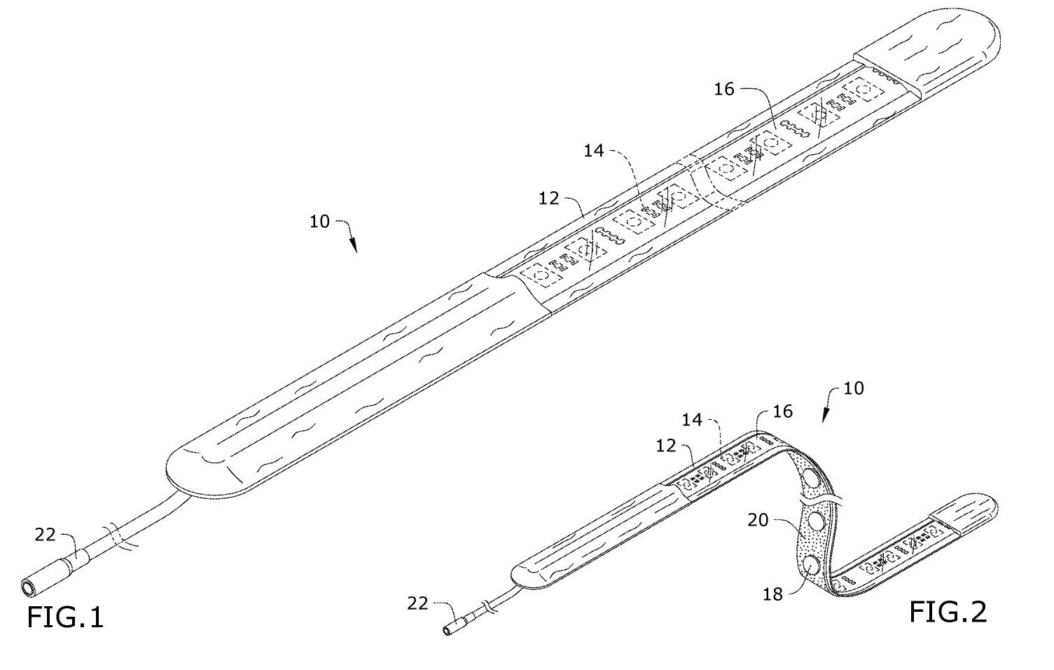

As seen in reference to FIG. 1, a LED lighting strip 10 may be made in any desired length to accommodate illumination of a desired area. The LED lighting strip 10 includes an elongate first film layer 12 having light reflective front surface and a light blocking back surface. The first film layer 12 will have a length that is substantially longer than a width of the layer. The first film layer 12 may be a poly film material, such as Panda Film, manufactured by Shandong Lufangyuan Plastic Industries Co of Shandong, China, having a white, light reflective front surface and a black light blocking back surface.

At least one LED lamp strip 14, having a plurality of electrically interconnected LED lamps is attached to an outer surface of the first film layer 12. The LED lamp strip 14 is preferably flexible along its longitudinal length and may also be torsionally flexible along the longitudinal length. This plurality of electrically interconnected LED lamps can be single or double row flexible light emitting diode (LED) lighting strips. The LED lamp strip 14 is covered by a second film layer 16 formed of a clear vinyl material. The vinyl material may, for example be 20-40 gauge clear vinyl that is adhered over the LED lamp strip 14.

A power connector 22 is attached to a conductor extending from at least one end of the LED lighting strip 10 for electrical connection of the LED lamps 14 with an electrical power source, such as a battery 24. As will be appreciated, a second power connector 22 may be provided at each end for interconnection with a second LED lighting strip 10.

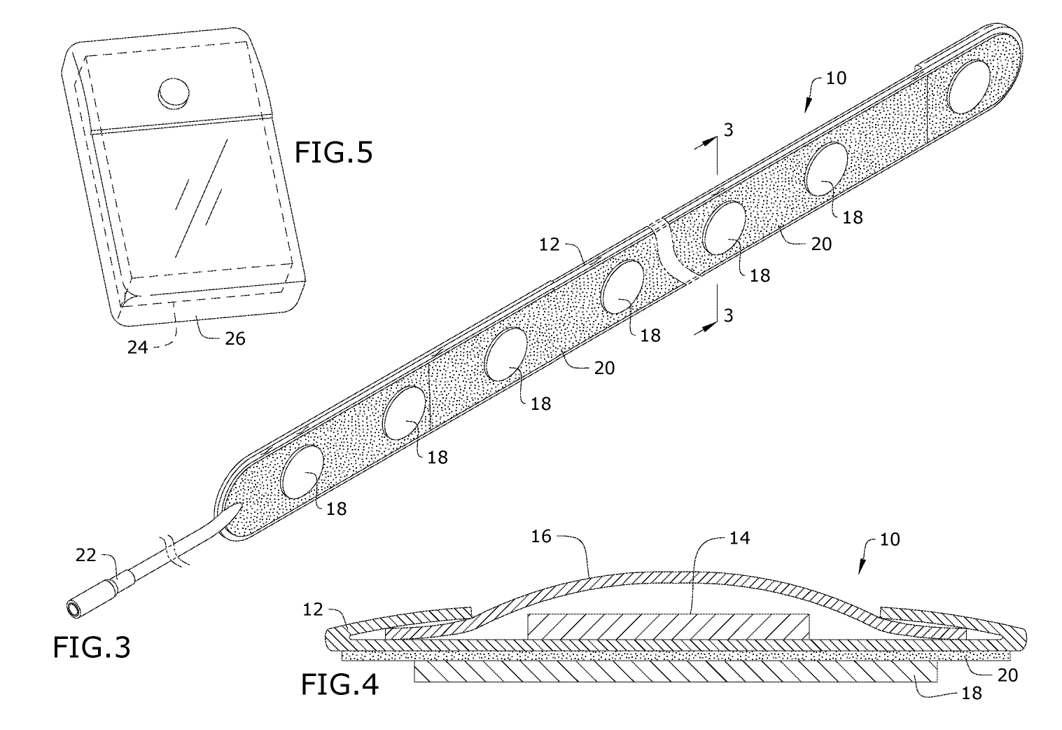

As seen in reference to FIGS. 2 and 3, the LED lighting strip 10 is formed as a flexible assembly. A back surface of the LED lighting strip 10 may include one or more fasteners to temporarily mount the LED lighting strip to an area requiring illumination. The one or more fasteners may include a layer of pile material 20 of a loop or hook and pile fastener which may be attached along the length of the back surface. The pile material 20 may also be attached as a plurality of segments configured in a spaced apart relation along the back surface. The layer of pile material 20 may be interconnected with a strip or strips of a cooperating loop and hook material that may be applied to a mounting surface in the area to be illuminated.

The one or more fasteners may also include a plurality of magnets 18 that are arranged in a spaced apart relation along the back surface of the LED lighting strip. By way of non-limiting example, the magnets 18 may be 15 mm in diameter and 2 mm thickness disks which may be adhered to the back surface of the LED lighting strip 10. When utilized in conjunction with a pile fastener materials, the magnets 18 may be slightly embedded within a cutout in the pile material 20 or interposed between or under the segments of the pile material 20. The magnets 18 provide for mounting to metallic surfaces, such as signage, doors, lockers, and body parts of a motor vehicle. The magnets 18 may also engage with one another to secure the light strip around an object. The LED light strip 10 may also include a reinforcement and an aperture at its opposed ends to accommodate the insertion of a screw, nail, or pin.

In reference to FIG. 4, a fold is formed along the side edges of the first film layer 12 to form a pocket for receiving the side edges of the second film layer 16. The first film layer 12 and the second film layer 16 are sealingly joined to encapsulate the LED lamp strip 14 therein. The seal may be formed by a stitch, a weld, or an adhesive. Preferably, the seal is watertight so that the LED lighting strip may be utilized in areas with considerable moisture, such as outdoors, shower areas, and the like.

As seen in reference to FIG. 5, the power source may include a battery 24 and a battery case 26 or enclosure for containing and mounting the battery. For use in moisture environments, the enclosure should also be moisture resistant. The battery case 26 may include a switch to activate the plurality of LED lamps 14 carried by the LED lighting strip 10. For example, the battery case 26 may be configured to contain a 12 V 3000-9500 MAH batteries 24. The power ratings of the battery 24 may be selected based on the power requirements of the LED lamp strip 14 based on the number of lamps, the length of the strip, light intensity, and the desired illumination duration for the area.

The battery case may also be configured as a rechargeable battery case. Alternatively, AC/DC power converter/charger plugin adapter may be utilized as the power source to operate the strip. The battery case 26 may be formed of a 20-40 gauge clear vinyl formed in a pocket that contains the rechargeable battery 24. The pocket has pile material on the backside of it, and, may also include magnets 18 for attaching to metal or the pile material pieces.

The battery case 26 may also be configured with a wireless transceiver that may communicate with a mobile computing device. The mobile computing device may have an app that communicates with the wireless transceiver to operate the LED light strip 10. The app may be utilized to power on the LED light strip 10, power off the LED light strip 10, dim, flash, or otherwise control the LED light strip 10.

It should be understood, of course, that the foregoing relates to exemplary embodiments of the invention and that modifications may be made without departing from the spirit and scope of the invention as set forth in the following claims.

What is claimed is:

1. A flexible light emitting diode (LED) lighting strip, comprising:
an elongate first film layer having a light reflective front surface and a light blocking back surface;
a plurality of electrically interconnected LED lamps attached in a spaced apart relation along a longitudinal length of the first film layer;
a second film layer covering the plurality of electrically interconnected LED lamps and joined to the first film layer;
one or more fasteners attached to the back surface; and
a connector in electrical communication with the plurality of electrically interconnected LED lamps, the connector configured to connect with a power source.

2. The flexible LED lighting strip of claim 1, further comprising:
a battery pack.

3. The flexible LED lighting strip of claim 2, wherein the batter pack comprises:
a rechargeable battery.

4. The flexible LED lighting strip of claim 3, wherein the battery pack further comprises:
a recharging circuit.

5. The flexible LED lighting strip of claim 1, further comprising:
a power source configured as an AC to DC converter.

6. The flexible LED lighting strip of claim 1, further comprising:
a fold formed along a side edge of the first film layer to form a pocket; and
a lateral edge of the second film layer is received within the pocket and joined with the first film layer.

7. The flexible LED lighting strip of claim 6, wherein the second film layer is joined with the first film layer via a plurality of stitches extending through the fold.

8. The flexible LED lighting strip of claim 6, wherein the second film layer is joined with the first film layer via a weld along the fold.

9. The flexible LED lighting strip of claim 6, wherein the second film layer and the first film layer are joined in a watertight seal to encapsulate the plurality of LED lamps.

10. The flexible LED lighting strip of claim 6, wherein the one or more fasteners comprises:
a length of pile material attached to the back surface.

11. The flexible LED lighting strip of claim 6, wherein the one or more fasteners comprises:
one or more magnets attached to the back surface.

12. The flexible LED lighting strip of claim 11, wherein the magnets are attached in a spaced apart relation along the longitudinal length of the LED lighting strip.
